(19) United States
(12) Patent Application Publication
(10) Pub. No.: US 2025/0053645 A1
(43) Pub. Date: Feb. 13, 2025

(54) Memory Hybrid-Dynamic Vulnerability Assessment

(71) Applicant: Virsec Systems, Inc., San Jose, CA (US)

(72) Inventor: Danny Kim, San Jose, CA (US)

(21) Appl. No.: 18/719,359

(22) PCT Filed: Dec. 29, 2022
(86) PCT No.: PCT/US2022/082511

§ 371 Date: Jun. 13, 2024

Related U.S. Application Data
(60) Provisional application No. 63/266,119, filed on Dec. 29, 2021.

(51) Int. Cl. G06F 21/54; G06F 21/55

(52) U.S. Cl. CPC G06F 21/54; G06F 21/554; G06F 21/556

(57) ABSTRACT

Embodiments identify legitimate application code paths and protect applications from malicious attacks. Responsive to loading code of an executing application into memory, one or more call instructions in the code are identified. In turn, a list of one or more legitimate return instruction destinations is created based on the identified one or more call instructions. In this way, legitimate code paths of the application are identified. This identified list of legitimate return instruction destinations is used to control the execution of the application so as to protect against malicious attacks. An embodiment, upon encountering a given return instruction, determines if a given destination of the given return instruction is approved or unapproved.

### RELATED APPLICATION

This application claims the benefit of U.S. Provisional Application No. 63/266,119, filed on Dec. 29, 2021.

The entire teachings of the above application are incorporated herein by reference.

### BACKGROUND

With each passing day, cyber-attacks are becoming increasingly sophisticated. Attacks are often targeted to exploit specific vulnerabilities in specific applications. Various methods and tools exist for identifying and protecting against these vulnerabilities in applications, but these existing methods and tools are inadequate.

### SUMMARY

Embodiments provide improved systems, methods, and computer program products to protect against cyber-attacks.

An example embodiment to directed to a computer-implemented method that, responsive to loading code of an executing application into memory, identifies one or more call instructions in the code. In turn, the method, based on the identified one or more call instructions, creates a list of one or more legitimate return instruction destinations. In this way, such an embodiment identifies legitimate code paths of the application.

Another embodiment causes execution of the application to pause prior to identifying the one or more call instructions. Such an embodiment may, after creating the list of one or more legitimate return instruction destinations, cause execution of the application to resume and control the execution of the application based on the created list of one or more legitimate return instruction destinations.

According to an embodiment, controlling the execution of the application based on the created list of one or more legitimate return instruction destinations includes, upon encountering a given return instruction, determining if a given destination of the given return instruction is approved or unapproved. In such an embodiment, execution of the application is allowed to continue responsive to the given destination being an approved destination. Further, responsive to the given destination being an unapproved destination, such an embodiment: (i) checks the given destination of the given return instruction against the list of one or more legitimate return instruction destinations and (ii) controls the execution of the application based on the checking. In an embodiment, an approved destination is a destination previously determined to be in the list of one or more legitimate return instruction destinations and an unapproved destination is a destination not previously determined to be in the list of one or more legitimate return instruction destinations.

According to an embodiment, controlling the execution based on the checking comprises, responsive to the given destination being in the list of one or more legitimate return instruction destinations, allowing execution of the application to continue and, responsive to the given destination not being in the list of legitimate return instruction destinations, declaring a security attack. Such an embodiment may further include responsive to declaring the security attack, implementing a protection action. In embodiments, protection actions may include any such actions known to those of skill in the art. Non-limiting example protection actions include at least one of: blocking the given destination from being reached, terminating execution of the application, and logging the given destination. According to an embodiment, the security attack is a return-oriented programming attack or buffer overflow attack.

Further still, in an embodiment, the application is executed utilizing a Dynamic Binary Instrumentation (DBI) tool. According to an embodiment, utilizing a DBI tool enables embodiments to pause, resume, and otherwise control execution of the application.

Another example embodiment is directed to a computer system. The computer system includes a processor and a memory with computer code instructions stored thereon. In such an embodiment, the processor and the memory, with the computer code instructions, are configured to cause the system to implement any embodiment or combination of embodiments described herein.

Yet another embodiment is directed to a computer program product. The computer program product comprises one or more non-transitory computer-readable storage devices and program instructions stored on at least one of the one or more storage devices. The program instructions, when loaded and executed by a processor, cause an apparatus associated with the processor to implement any embodiment or combination of embodiments described herein.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is simplified diagram of an application that may be protected using embodiments.

FIG. 2 is a simplified diagram of instructions and storage thereof, of the application depicted in FIG. 1.

FIG. 3 is a simplified diagram of instructions and data, and the storage thereof, of an application that may be protected using embodiments.

FIG. 4 is simplified diagram of use and exploitation of the application depicted in FIG. 3.

FIG. 5 is a flowchart of a method for identifying legitimate application code paths and protecting an application from malicious attacks, according to an embodiment.

FIGS. 6A-C illustrate a method of protecting an application from attacks, according to an example embodiment.

FIG. 7 depicts a computer network or similar digital processing environment in which embodiments may be implemented.

FIG. 8 is a diagram illustrating an example internal structure of a computer in the environment of FIG. 7.

### DETAILED DESCRIPTION

A description of example embodiments follows. Embodiments provide improved functionality to identify legitimate application code paths and protect applications from attacks.

In recent years, there has been a shift in the security industry towards protecting application runtime. Many security tools today claim runtime protection, but offer runtime protection from outside of the application through mechanisms like an enhanced web application firewall. These external approaches to runtime protection are still failing to protect applications from attacks such as Return-Oriented Programming (ROP) that target the application's memory. There is an increased desire and need to monitor the application's runtime from within to provide more deterministic protection.

ROP attacks work by causing the application to diverge from its intended control flow. To defend against this, Control-Flow Integrity (CFI) is an approach that ensures an application only follows its intended paths. Theoretically, CFI is the perfect defense against these types of attacks and can deterministically ensure that an application is not hijacked during its runtime. This type of approach (e.g., CFI) is needed to provide a novel deterministic level of protection against these increasingly sophisticated attackers. However, traditional CFI in practice, cannot be implemented in a way that meets the constraints of enterprise grade applications.

There are two primary issues with CFI in practice. The first issue is determining/obtaining an application's legitimate code paths. The legitimate code paths of an application are an assembly instruction-level understanding of where each code transition is intended to go. Obtaining this information without access to source code, which is common in enterprise environments especially when third-party applications are in use, is a known hard problem for x86-based applications. Without accurate knowledge of legitimate code paths, CFI cannot be enforced properly. Even if the knowledge of code paths is slightly inaccurate, this results in false positives or false negatives. Second, enforcing CFI at runtime requires an instruction-level monitoring of an application during the application's runtime. CFI requires a notification every time the application has a code transition. Code transitions in an application are common, and intercepting each transition results in a prohibitive slowdown in the application's performance.

Attempts have been made to provide runtime protection, and these runtime application protection attempts have generally been handled differently by different providers. There are tools such as Signal Sciences[1] (bracketed numbers in this document refer to the enumerated list of references hereinbelow), Imperva[2], and Contrast Security[3] that offer runtime application protection, but do not guarantee protection against ROP-based attacks. Furthermore, the approaches of Signal Sciences[1], Imperva[2], and Contrast Security[3] are targeted towards web applications and do not monitor an application's internal control flow. Without this visibility, these tools (Signal Sciences[1], Imperva[2], and Contrast Security[3]) cannot offer the same kind of runtime memory protection that embodiments, which may be referred to herein as “Virsec Security Platform (VSP) memory,” offers.

There are also endpoint protection tools such as Palo Alto Traps[4], Crowdstrike[6], and Mcafee[6] that offer continuous monitoring and detection through a variety of methods such as Machine Learning and behavior analysis. These tools typically rely on peripheral information from the system and/or network to detect when an endpoint is compromised. Again, without instruction-level visibility, these tools cannot obtain the same deterministic and reliable detection against memory-based attacks that embodiments provide.

A few providers, such as Karambe[7] and Runsafe[8], offer runtime memory protection. However, Karambe[7] only claims protections for embedded systems, which are not typically x86 application binaries. Runsafe[8] offers runtime memory protection by transforming the application binary and changing how the application loads its code into memory. This is done either statically or at load-time when the application first starts. This approach (Runsafe[8]), while offering some protection against memory-based attacks, is not as comprehensive and deterministic as embodiments for several reasons.

First, the static transformation implemented by Runsafe[8] is only performed once. After the transformation is complete, the binary has no further protection and, thus, Runsafe[8] cannot guarantee that the application has not been hijacked after it is launched. Runsafe's[8] second option, which performs the static transformation at load time, at the beginning of each and every application start, still does not offer any actual runtime monitoring of the application. The Runsafe[8] tool starts and stops after the application is loaded into memory and has no mechanism for detecting or stopping memory-based attacks.

Embodiments solve these problems and provide runtime application protection. Embodiments, i.e., VSP memory, implement a modified version of CFI that is capable of detecting ROP and similar buffer overflow attacks with sufficiently low runtime overheads and no prior knowledge of the application code paths. Embodiments can detect attacks in real time and even stop attacks inline before the attacks succeed. Because embodiments are based on CFI, embodiments have near-zero false positives and offer a deterministic approach that is not learned and instead based on core binary code tenets.

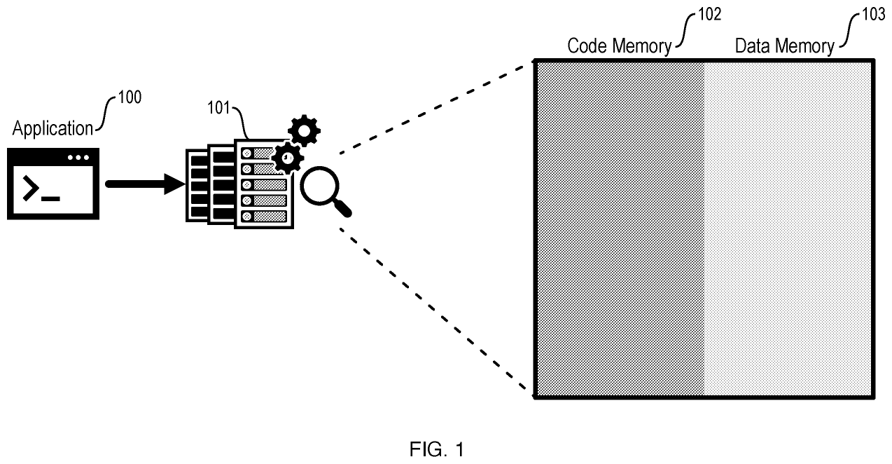

FIG. 1 is a simplified diagram of an application 100 that may be protected using embodiments. The application, i.e., computer program, 100 is a series of instructions 101 and the application 100 relies on two primary sections of memory, code memory 102, and data memory 103.

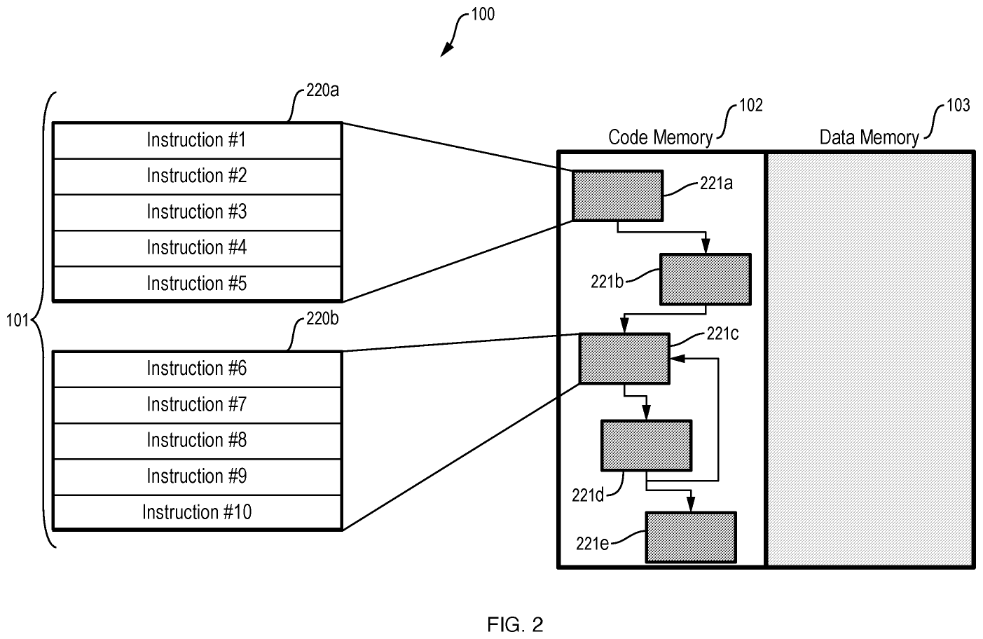

FIG. 2 is a simplified diagram further illustrating the instructions 101 and storage thereof, of the application 100 depicted in FIG. 1. In this non-limiting example, the instructions 101 are formed of two sets of instructions, 220a and 220b. The instruction set 220a includes the instructions 1-5 and the instruction set 220b includes the instructions 6-10. The instructions 101 are stored in blocks 221a-e of the code memory 102. For instance, the instruction set 220a is stored in the block 221a of code memory 102 and the instruction set 220b is stored in the block 221c of code memory 102. The application 100 and the application's 100 behavior, like all applications, breaks down to a sequence of instructions 101. Specifically, the application's 100 behavior can be controlled by the specific sequence of instructions the application 100 follows, e.g., the order in which instructions 1-5 of set 220a are executed. Control of an application's sequence of code (instructions) leads to the control of the application.

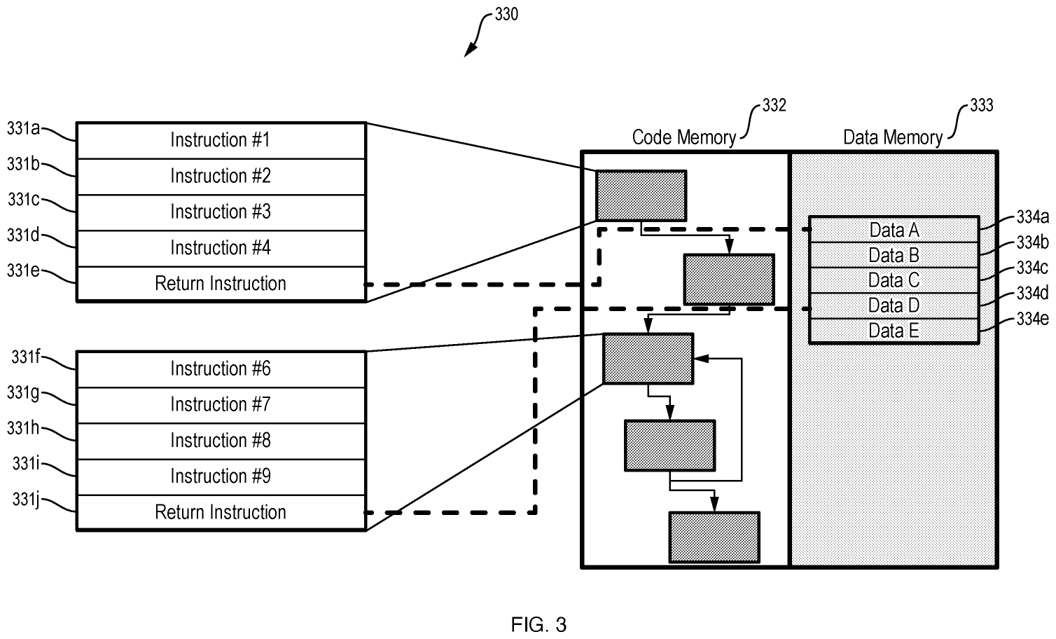

FIG. 3 is another simplified diagram of an application 330 that may be protected using embodiments. The application 330 is formed of instructions 331a-j stored in blocks of code memory 332. Like the application 100 described hereinabove, behavior of the application 330 is a function of the order with which the instructions 331a-j are executed. Moreover, behavior of the application 330 is also a function of data 334a-e stored in the data memory 333. This is because the instructions 331e and 331j, of the application 330, rely on the data 334a and 334d, respectively, on where to go next, i.e., what instruction to next execute. As such, control/behavior of the application 330 is tied to the data memory 333 and data 334a-e stored thereon.

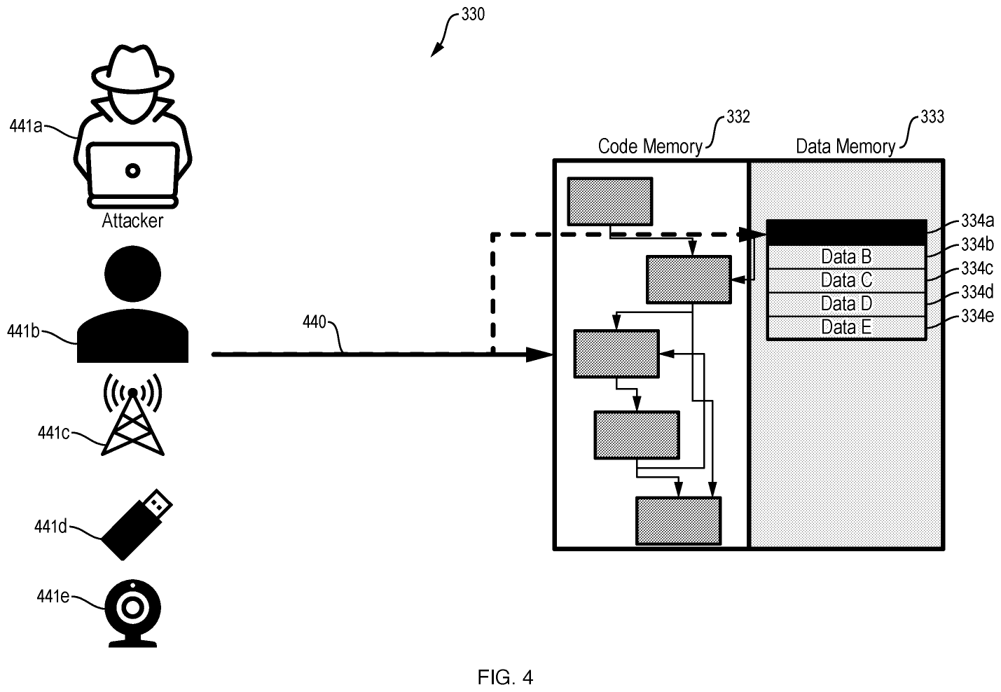

FIG. 4 is simplified diagram of use and exploitation of the application 330. In this example, the application 330, like most applications, receives input 440 from one of the external sources 441a-e. The input 440 is saved in the data memory 333 at data location 334a. As described above, behavior of the application 330 relies on the data 334a and, as such, the input 440 can modify behavior of the application 330. When input is from legitimate sources, e.g., 441b-e, behavior modification caused by the input 440 is typically not problematic. However, attackers, 441a, can craft malicious input 440 that has a negative impact or otherwise comprises the application 330 and/or computing device(s) on which the application 330 is executing. Such malicious input 440 can overwrite critical sections of the application's 330 memory and enable attacker 441a to gain control of the application 330. Embodiments prevent such malicious actions.

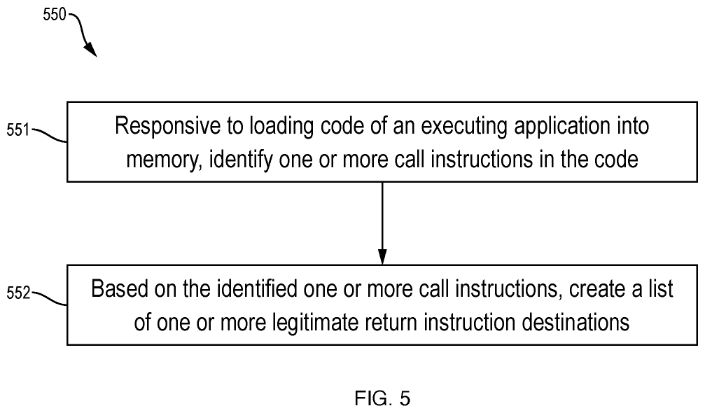

FIG. 5 is a flowchart of one such example method 550 that identifies legitimate application code paths and protects applications from malicious attacks. The method 550 is computer implemented and, as such, may be implemented using any computing device, or combination of computing devices known in the art.

The method 550 begins at step 551 where, responsive to loading code of an executing application into memory, one or more call instructions in the code are identified. According to an embodiment, the call instructions are identified in the code through limited dynamic disassembly. When new code is being loaded into a code cache, such an embodiment has the opportunity to examine the code. During this examination, disassembly (the process of turning machine code/binary into assembly, which is understandable) is run. The code in assembly form is examined to identify the call instructions. In turn, at step 552, a list of one or more legitimate return instruction destinations is created based on the identified one or more call instructions (from step 552). In this way, the method 550 identifies legitimate code paths of the application. To illustrate, it is a tenet of instruction level behavior that after a call, and executing instructions pursuant to the call, e.g., a function, an application returns to the address immediately after the call. Thus, for every call identified at step 551, a corresponding return destination, the address immediately after the call, is identified and added to the list of legitimate return instruction destinations at step 552. Advantageously, the method 550 identifies the legitimate code paths without access to the original source code of the application and without doing a full static disassembly of the application. This is a significant improvement over existing methods, which require source code access and a static disassembly to understand the code.

While the method 550 functionality of identifying legitimate code paths provides significant improvements over existing functionality, embodiments of the method 550 go further and utilize the created list of legitimate return instruction destinations to protect the application from malicious attacks. One such embodiment of the method 550 causes execution of the application to pause prior to the identifying the one or more call instructions at step 551. Such an embodiment may, after creating the list of one or more legitimate return instruction destinations at step 552, cause execution of the application to resume and control the execution of the application based on the created list of one or more legitimate return instruction destinations (from step 552). In an embodiment of the method 550, the application is executed utilizing a Dynamic Binary Instrumentation (DBI) tool, such as DynamoRIO. According to an embodiment, utilizing a DBI tool enables embodiments of the method 550 to pause, resume, and otherwise control execution of the application.

According to an embodiment, controlling the execution of the application based on the created list of one or more legitimate return instruction destinations includes, upon encountering a given return instruction, determining if a given destination of the given return instruction is approved or unapproved. In such an embodiment, execution of the application is allowed to continue responsive to the given destination being an approved destination. Conversely, responsive to the given destination being an unapproved destination, such an embodiment: (i) checks the given destination of the given return instruction against the list of one or more legitimate return instruction destinations and (ii) controls the execution of the application based on the checking. In an embodiment of the method 550, an approved destination is a destination previously determined to be in the list of one or more legitimate return instruction destinations and an unapproved destination is a destination not previously determined to be in the list of one or more legitimate return instruction destinations. In other words, if a destination was previously evaluated and determined to be legitimate (i.e., in the list), the destination is considered “approved,” and if a destination was not previously evaluated, the destination is considered “unapproved” and is checked.

According to an embodiment of the method 550, controlling the execution based on the checking comprises, responsive to the given destination being in the list of one or more legitimate return instruction destinations, allowing execution of the application to continue and, responsive to the given destination not being in the list of legitimate return instruction destinations, declaring a security attack. Such an embodiment may further include, responsive to declaring the security attack, implementing a protection action. In embodiments, protection actions may include any such actions known to those of skill in the art. Example protection actions include at least one of: blocking the given destination from being reached, terminating execution of the application, and logging the given destination. In this way, embodiments of the method 550 protect the application from security attacks, such as return-oriented programming attacks and buffer overflow attacks, amongst other examples.

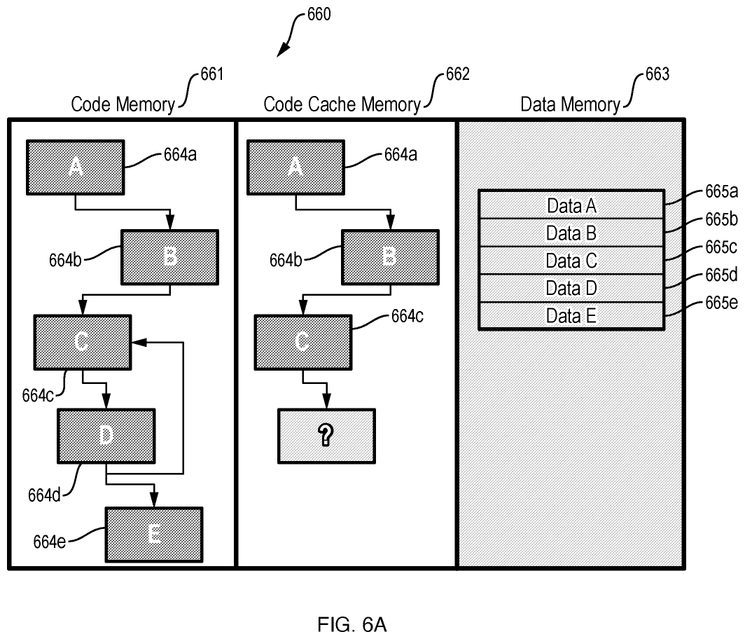

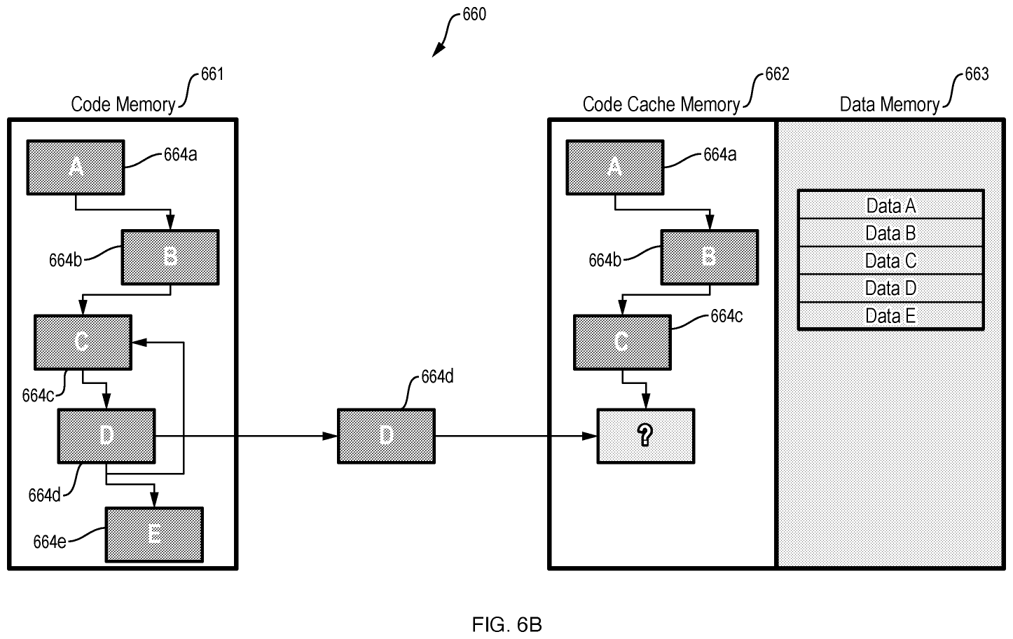

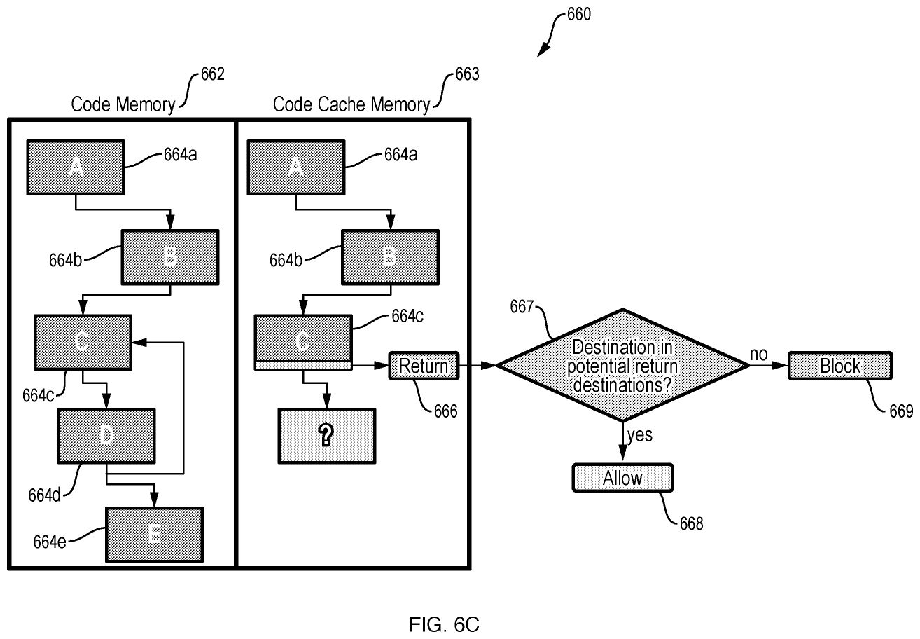

FIGS. 6A-C illustrate a method of protecting an application 660 from attacks, according to an embodiment.

FIG. 6A illustrates the application 660 and three memory areas, code memory 661, code cache memory 662, and data memory 663, that are associated with the application 660. The code memory 661 stores basic blocks 664a-e, which are blocks of instructions that make up the application 660. The data memory 663 stores data 665a-e that is used by the application 660. Further, the code cache memory 662 is cache memory that is used to temporarily store instructions of the application 660 for execution. The code cache 662 is introduced by an embodiment's use of a code-cache DBI tool, such DynamoRIO. The DBI tool is able to maintain control of the application because the DBI tool controls the code cache 662 from where the application is actually running. The code cache 662 is a copy of the application's real code memory with the caveat that the DBI tool controls that code cache memory 662. In the instance of the application 660 depicted in FIG. 6A, the code blocks 664a-c have been executed and, as such, have been loaded into code cache memory 662.

To implement the functionality described herein, an embodiment uses a code cache-based DBI tool to track execution of the application, e.g., 660. In an embodiment, as the application executes a portion of code for the first time, such an embodiment loads that new portion of code into the code cache 662. As noted above, in FIG. 6A, the blocks 664a-c have been executed and, as such, the blocks 664a-c have been loaded into the code cache 662. When the application 660 continues execution, such an embodiment loads the next basic block, 664d into the code cache memory 662. FIG. 6B illustrates such functionality.

Specifically, FIG. 6B illustrates loading block 664d into the code cache memory 662. According to an embodiment, when the basic block 664d is being loaded into the code cache 662, the basic block 664d is inspected for potential return destinations (addresses that come after a call instruction). When a return destination is identified, this destination (or some indicator thereof) is stored and, in this way, a list of legitimate return instructions is generated. In the example depicted in FIG. 6B, blocks 664a-c are loaded in code cache memory 662 and block 664d is being loaded into code cache memory 662. As such, legitimate return instruction destinations for the code in blocks 664a-d is identified by embodiments.

Embodiments are able to build a reliable set of potential return instructions because: (1) a call instruction is made prior to its corresponding return, (2) an application must have its basic block loaded into the code cache 662 to continue to execute, and (3) embodiments control execution of the application to provide an opportunity to inspect each basic block prior to loading it into the code cache 662. Further, embodiments, at least partially, maintain a low steady-state performance overhead because this loading of the basic blocks is typically only done once per application execution. As such, inspection to identify legitimate return destinations is only performed once per execution instance.

FIG. 6C illustrates a sequence of protecting the application 660 during execution. In FIG. 6C, blocks 664a-c are loaded into code cache memory 662 and, as such, the blocks 664a-c have been inspected to identify legitimate return instruction destinations associated with the application 660. During execution, the application 660 basic block 664c is attempting to jump to a basic block (664d) that is not present in its code cache 663 and the instruction causing the loading of code is a return instruction 666. As such, an embodiment receives a callback, e.g., from a DBI tool, which causes such an embodiment to inspect 667 the destination of the return instruction 666. If the destination is in the previously identified list of return destinations (yes at 667), such an embodiment allows 668 execution of the application 660 to continue and the application 660 execution moves to the destination. However, if the destination is not in the previously identified list of return destinations (no at 667), such an embodiment blocks 669 execution of the application 660.

Embodiments have low steady-state performance overhead because, for most applications in the steady-state, return instructions rarely go to new code locations. In the steady-state, embodiments do not require any runtime intervention or inspection while the application is running. This is because such an embodiment only receives a call-back to check a destination the first time a destination is encountered.

To map legitimate code paths, embodiments uses a DBI tool to instrument any application. The DBI tool gives embodiments instruction-level information about each code segment that the application executes. The instructions that the application is going to execute are only loaded once, which minimizes the steady state overhead of the analysis that embodiments perform.

With the opportunity to analyze the instructions of the application, embodiments look for two key instructions: the call instruction and the return instruction. A core tenet of application instruction-level behavior is that the return instruction jumps to an instruction immediately following a call instruction. This also means that a call instruction should always be executed prior to the return instruction executing. With this key fact, embodiments are able to pseudo-dynamically build a set of legitimate return instruction destinations while the application is executing. When a return instruction is observed, embodiments execute minimal code to detect where the return instruction is jumping. The destination is verified at runtime against the list of legitimate return destinations built during runtime. This check is done in real time, meaning embodiments can also stop attacks before they execute. Embodiments can ensure that all legitimate return destinations will be in the embodiments' return map because the corresponding call instruction must have executed prior.

With the knowledge of where returns should go, an embodiment maintains a sufficiently low latency overhead by only intercepting the application's runtime at two key points. First, such an embodiment examines the application code as it is loaded into memory, which typically only occurs once per execution. Such an embodiment intercepts the execution here in order to look for possible return destinations. Because application code is only loaded into memory once, this runtime cost is only incurred once. Second, such an embodiment intercepts the application's execution when a return instruction goes to code that has not yet been loaded into memory. This interception allows the embodiment to dynamically check that the return destination exists in its return map. This occurs often during the initialization of the application because the application has not loaded much of its code into the code cache. However, once the application reaches the steady state, return instructions rarely go to new locations, which means embodiments incur minimal steady state latency overhead.

Moreover, in contrast to most other CFI-based approaches, embodiments do not have to insert any code that is executed every time a return instruction is executed. Most other approaches insert some code after every return instruction to save the real-time destination of the return. As such, even if such an existing approach has perfect knowledge of an application's legitimate code paths, such an existing approach is, nonetheless, computationally expensive to execute. An embodiment optimizes this approach and only runs its return-analysis code when a return instruction is jumping to a location unseen by said embodiment. This means that in the steady state, once most of the code that is being used has already been executed, embodiments incur near-zero latency overheads.

With this implementation, embodiments can detect when a return instruction jumps to a location that is an illegitimate call site. This is not perfect CFI; however, it does eliminate more than 98% of destinations within an application significantly increasing the bar of difficulty to execute a buffer overflow attack [9]. Additionally, ROP and buffer overflow attacks typically rely on more than one errant return, which increases the chances of detection by embodiments.

Embodiment's, i.e., VSP memory's approach offers three main advantages: deterministic detection, inline protection, and no prior knowledge requirement. Because embodiments are based on CFI and rely on core binary code tenets, the detection provided by embodiments is not probabilistic and, rather, based on rules that all applications, no matter their origin or use case, need to follow. This offers near-zero false positives in comparison to other approaches. Embodiments can also offer inline protection because they can be run inside of the application and intercept the application's execution in real time. During this interception, embodiments can check the legitimacy of code transitions and have the ability to stop the application prior to illegitimate transitions. This level of accuracy and speed is unprecedented for this type of detection. Further, embodiments are able to build a map of intended paths as the application executes. Embodiment's novel approach to generating this map means that there is no source code requirement or pre-analysis required. Embodiments do not need to know about the application at all prior to launching the application. Embodiments can offer deterministic, inline detection and protection from the first time they launch an application.

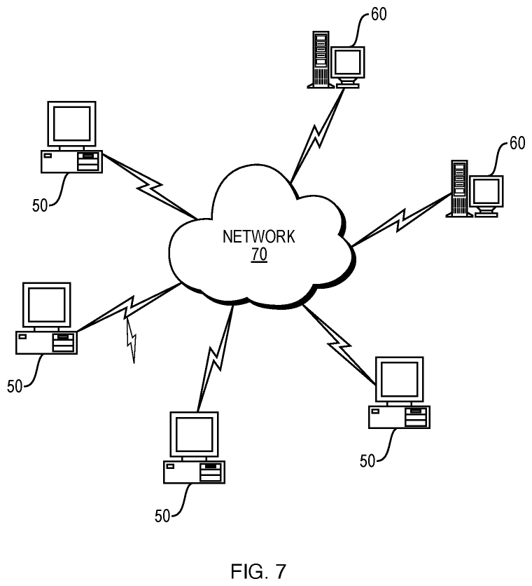

FIG. 7 illustrates a computer network or similar digital processing environment in which embodiments of the present disclosure may be implemented.

Client computer(s)/devices 50 and server computer(s) 60 provide processing, storage, and input/output devices executing application programs and the like. The client computer(s)/devices 50 can also be linked through communications network 70 to other computing devices, including other client devices/processes 50 and server computer(s) 60. The communications network 70 can be part of a remote access network, a global network (e.g., the Internet), a worldwide collection of computers, local area or wide area networks, and gateways that currently use respective protocols (TCP/IP, Bluetooth®, etc.) to communicate with one another. Other electronic device/computer network architectures are suitable.

Client computers/devices 50 and/or servers 60 may be configured, alone or in combination, to implement the embodiments described herein, e.g., the method 550, amongst other examples. The server computers 60 may not be separate server computers but part of cloud network 70.

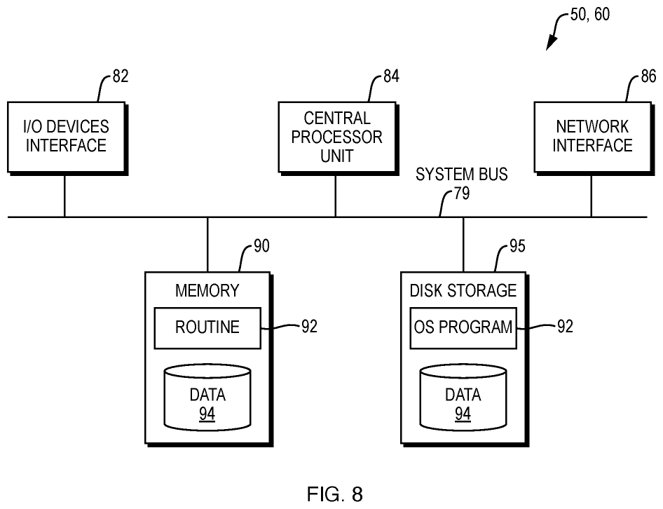

FIG. 8 is a diagram of an example internal structure of a computer (e.g., client processor/device 50 or server computers 60) in the computer system of FIG. 7. Each computer 50, 60 contains a system bus 79, where a bus is a set of hardware lines used for data transfer among the components of a computer or processing system. The system bus 79 is essentially a shared conduit that connects different elements of a computer system (e.g., processor, disk storage, memory, input/output ports, network ports, etc.) that enables the transfer of information between the elements. Attached to the system bus 79 is an input/output (I/O) device interface 82 for connecting various input and output devices (e.g., keyboard, mouse, displays, printers, speakers, etc.) to the computer 50, 60. A network interface 86 allows the computer to connect to various other devices attached to a network (e.g., network 70 of FIG. 5). Memory 90 provides volatile storage for computer software instructions 92 and data 94 used to implement an embodiment of the present disclosure (e.g., the method 550, amongst others). Disk storage 95 provides non-volatile storage for computer software instructions 92 and data 94 used to implement an embodiment of the present disclosure. A central processor unit 84 is also attached to the system bus 79 and provides for the execution of computer instructions.

Embodiments or aspects thereof may be implemented in the form of hardware including but not limited to hardware circuitry, firmware, or software. If implemented in software, the software may be stored on any non-transient computer readable medium that is configured to enable a processor to load the software or subsets of instructions thereof. The processor then executes the instructions and is configured to operate or cause an apparatus to operate in a manner as described herein.

Further, hardware, firmware, software, routines, or instructions may be described herein as performing certain actions and/or functions of the data processors. However, it should be appreciated that such descriptions contained herein are merely for convenience and that such actions in fact result from computing devices, processors, controllers, or other devices executing the firmware, software, routines, instructions, etc.

It should be understood that the flow diagrams, block diagrams, and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and, thus, the data processors described herein are intended for purposes of illustration only and not as a limitation of the embodiments.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

### REFERENCES

[1.] https://www.signalsciences.com/products/rasp-runtime-application-self-protection/
[2.] https://www.imperva.com/products/runtime-application-self-protection-rasp/
[3.] https://www.contrastsecurity.com/runtime-application-self-protection-rasp?&lead_source_category=Adwords-PPC&device=c&utm_campaign=Search+%7C+US+%7C+Product+%7C+RASP+% 7C+Exac t&utm_source=adwords&utm_medium=ppc&utm_term=rasp%20runtime%20application&hs a_kw=rasp%20runtime%20application&hsa_net=adwords&hsa_grp=106819105103&hsa_ca m=11023369891&hsa_acc=8744023377&hsa_tgt=kwd-1082910836312&hsa_ver=3&hsa_ad=461317274628&hsa_mt=e&hsa_src=g&gclid=CjwKC AjwpMOIBhBAEiwAy5M6YF_t5mI-wOcmVPBFZ8DWcVE-01L2qJyqGW1Emqxy1I-Km_4jjeZWuxoC11IQAvD_BWE
[4.] https://docs.paloaltonetworks.com/traps.html
[5.] https://www.crowdstrike.com/cybersecurity-101/endpoint-security/
[6.] https://www.mcafee.com/enterprise/en-us/security-awareness/endpoint.html
[7.] https://karambasecurity.com/products/suite
[8.] https://runsafesecurity.com/
[9.] https://www.usenix.org/sites/default/files/conference/protected-files/zhang_sekar_sec13_slides.pdf

What is claimed is:

1. A computer-implemented method comprising:
responsive to loading code of an executing application into memory, identifying one or more call instructions in the code; and
based on the identified one or more call instructions, creating a list of one or more legitimate return instruction destinations, thereby identifying legitimate code paths of the application.

2. The method of claim 1 further comprising:
prior to the identifying, causing execution of the application to pause.

3. The method of claim 2 further comprising, after creating the list of one or more legitimate return instruction destinations:
causing execution of the application to resume; and
controlling the execution of the application based on the created list of one or more legitimate return instruction destinations.

4. The method of claim 3 wherein controlling the execution of the application based on the created list of one or more legitimate return instruction destinations comprises:
upon encountering a given return instruction, determining if a given destination of the given return instruction is approved or unapproved;
responsive to the given destination being an approved destination, allowing execution of the application to continue; and
responsive to the given destination being an unapproved destination: (i) checking the given destination of the given return instruction against the list of one or more legitimate return instruction destinations and (ii) controlling the execution of the application based on the checking.

5. The method of claim 4 wherein:
the approved destination is a destination previously determined to be in the list of one or more legitimate return instruction destinations; and
the unapproved destination is a destination not previously determined to be in the list of one or more legitimate return instruction destinations.

6. The method of claim 4 wherein controlling the execution based on the checking comprises:
responsive to the given destination being in the list of one or more legitimate return instruction destinations, allowing execution of the application to continue; and
responsive to the given destination not being in the list of legitimate return instruction destinations, declaring a security attack.

7. The method of claim 6 further comprising:
responsive to declaring the security attack, implementing a protection action.

8. The method of claim 7 wherein the protection action is at least one of:
blocking the given destination from being reached;
terminating execution; and
logging the given destination.

9. The method of claim 6 wherein the security attack is a return-oriented programming attack or buffer overflow attack.

10. The method of claim 1 wherein the application is executed utilizing a Dynamic Binary Instrumentation (DBI) tool.

11. A system comprising:
a processor; and
a memory with computer code instructions stored thereon, the processor and the memory, with the computer code instructions, being configured to cause the system to:
responsive to loading code of an executing application into memory, identify one or more call instructions in the code; and
based on the identified one or more call instructions, create a list of one or more legitimate return instruction destinations, thereby identifying legitimate code paths of the application.

12. The system of claim 11 wherein the processor and the memory, with the computer code instructions, are further configured to cause the system to:
prior to the identifying, cause execution of the application to pause.

13. The system of claim 12 wherein the processor and memory, with the computer code instructions, are further configured to cause the system, after creating the list of one or more legitimate return instruction destinations, to:
cause execution of the application to resume; and
control the execution of the application based on the created list of one or more legitimate return instruction destinations.

14. The system of claim 13 wherein, in controlling the execution of the application based on the created list of one or more legitimate return instruction destinations, the processor and the memory, with the computer code instructions, are configured to cause the system to:
upon encountering a given return instruction, determine if a given destination of the given return instruction is approved or unapproved;
responsive to the given destination being an approved destination, allow execution of the application to continue; and
responsive to the given destination being an unapproved destination: (i) check the given destination of the given return instruction against the list of one or more legitimate return instruction destinations and (ii) control the execution of the application based on the checking.

15. The system of claim 14 wherein:
the approved destination is a destination previously determined to be in the list of one or more legitimate return instruction destinations; and
the unapproved destination is a destination not previously determined to be in the list of one or more legitimate return instruction destinations.

16. The system of claim 14 wherein, in controlling the execution based on the checking, the processor and the memory, with the computer code instructions, are configured to cause the system to:
responsive to the given destination being in the list of one or more legitimate return instruction destinations, allow execution of the application to continue; and
responsive to the given destination not being in the list of legitimate return instruction destinations, declare a security attack.

17. The system of claim 16 wherein the processor and the memory, with the computer code instructions, are further configured to cause the system to:
responsive to declaring the security attack, implement a protection action.

18. The system of claim 17 wherein the protection action is at least one of:
blocking the given destination from being reached;
terminating execution; and
logging the given destination.

19. The system of claim 16 wherein the security attack is a return-oriented programming attack or buffer overflow attack.

20. A computer program product comprising:
one or more non-transitory computer readable storage devices and program instructions stored on at least one of the one or more storage devices, the program instructions, when loaded and executed by a processor, cause an apparatus associated with the processor to:
responsive to loading code of an executing application into memory, identify one or more call instructions in the code; and
based on the identified one or more call instructions, create a list of one or more legitimate return instruction destinations, thereby identifying legitimate code paths of the application.
